(19) United States
(12) Patent Application Publication
(10) Pub. No.: US 2009/0187529 A1
(43) Pub. Date: Jul. 23, 2009

(54) Method of Generating Behavior for a Graphics Character and Robotics Devices

(76) Inventors: Stephen John Regelous, Auckland (NZ); Stephen Noel Regelous, Auckland (NZ)

Correspondence Address: NIXON & VANDERHYE, PC, 901 NORTH GLEBE ROAD, 11TH FLOOR, ARLINGTON, VA, 22203, US

(21) Appl. No.: 11/884,866

(22) PCT Filed: Feb. 22, 2006
(86) PCT No.: PCT/NZ06/00025

§ 371 Date: Mar. 10, 2009

(30) Foreign Application Priority Data
Feb. 25, 2005 (NZ) 538487

(51) Int. Cl. G06N 7/00; G06N 5/02

(52) U.S. Cl. 706/53; 706/47

(57) ABSTRACT

The present invention relates to a method for determining behaviour of an autonomous entity within an environment using a weighted memory of observed objects, including the steps of: processing the weighted memory; generating an image of the environment from the perspective of the entity; recognizing visible objects within the image from a list of object types; storing data about the visible objects within the memory; and processing object data extracted from the memory in accordance with each object's type using an artificial intelligence engine in order to determine behavior for the entity. A system and software for determining behavior of an autonomous entity are also disclosed.

### FIELD OF INVENTION

The present invention relates to a method of generating behaviour for graphics characters and robotic devices. More particularly, but not exclusively, the present invention relates to a method of generating autonomous behaviour for graphics characters and robots using visual information from the perspective of the characters/robots.

### BACKGROUND OF THE INVENTION

It has been shown that generating character's behaviour using visual information from the perspective of the character has many advantages (patent publication WO/03015034 A1, A Method of Rendering an Image and a Method of Animating a Graphics Character, Regelous).

The system described in WO/03015034 is suitable for providing visual effects and animation. However, the system is less useful for robotics and complex simulation systems, such as pedestrian systems.

This is because the described system uses colour within an image to identify an object. Colour is not always sufficient as a means of identifying objects since there may be multiple objects of the same type (and hence same colour) occupying adjacent pixels

Furthermore there is no inherent memory for the character provided by the described system so the character only reacts to what is currently visible.

It is desirable to provide a system which provides realistic and effective simulation and robotic responses, and retains the efficiency and scalability benefits of vision-based systems.

It is an object of the invention to provide a method of generating behaviour for computer generated characters and robotic devices which meets this desire, or which at least provides a useful alternative.

### SUMMARY OF THE INVENTION

According to a further aspect of the invention there is provided a method for determining behaviour of an autonomous entity within an environment using a weighted memory of observed objects, including the steps of:
i) processing the weighted memory;
ii) generating an image of the environment from the perspective of the entity;
iii) recognising visible objects within the image from a list of object types;
iv) storing data about the visible objects within the memory; and
v) processing object data extracted from the memory in accordance with each object's type using an artificial intelligence engine in order to determine behaviour for the entity.

It is preferred that the step (i) of processing the weighted memory includes the sub-steps of:
modifying the weight of objects stored in the memory, preferably by reducing the weight;
calculating an expected location for the objects within the memory; and
modifying location data stored about the objects to correspond to its expected location.

The artificial intelligence engine may include a plurality of layers to determine behaviour for the entity. It is preferred that at least one of the layers is a fuzzy processing layer. It is further preferred that at least one of the layers is a fuzzy rules layer. One or more of the layers may be a neural network.

It is preferred that the object data is multiplexed during step (v).

The image may be generated in step (i) using a renderer or by using one or more cameras. It is preferred that the renderer uses a method which includes the steps of
a) performing a polar transformation to determine the position(s) of one or more vertices of a graphics primitive;
b) projecting the graphics primitive into sub images;
c) clipping the graphics primitive against the sub images to form clipped primitives;
d) performing polar transformations of the vertices of the clipped images;
e) interpolating across the surface of the clipped primitives to form pseudo polar sub images; and
f) combining the pseudo polar sub images to form an image.

Preferably the image includes a plurality of layers and one of the layers is an object layer providing information to identify an object instance at that pixel position. It is further preferred that the object instance includes velocity data, 3D location data, and object type.

The objects may be recognised in step (ii) using a visual recognition technique. Alternatively, the objects are recognised in step (ii) using an object layer of the image.

It is preferred that the method includes the step of flagging the modified objects within memory that should be visible but are not visible. It is further preferred that the objects that should be visible are those that should be visible within a sub-image of the image.

The behaviour may include turning, moving forward or backward, make sounds or facial expressions, activation of individual degrees of freedom for muscles (actuators) or motors, and control of animation blending controls.

The entity may be a robotic device or a computer generated character.

According to a further aspect of the invention there is provided a system for determining behaviour of an autonomous entity within an environment using a weighted memory of observed objects, including:
a memory arranged for storing the weighted memory of observed objects; and
a processor arranged for processing the weighted memory, generating an image of the environment from the perspective of the entity, recognising visible objects within the image from a list of object types, storing data about the visible objects within the weighted memory, modifying the weight of objects stored in the weighted memory depending on object visibility, and processing object data extracted from the weighted memory in accordance with each object's type using an artificial intelligence engine in order to determine behaviour for the entity.

### BRIEF DESCRIPTION OF THE DRAWINGS

Embodiments of the invention will now be described, by way of example only, with reference to the accompanying drawings in which:

FIG. 1: illustrates the first stage of processing of an image using a memory to obtain behaviour.

FIG. 2: illustrates the second stage of processing the image using the memory to obtain behaviour.

FIG. 3: shows an example of an artificial intelligence engine utilised to generate output values for the entity.

FIG. 3b: shows an example of an alternative artificial intelligence engine utilised to generate output values for the entity.

FIG. 4: shows a possible application of the invention for an autonomous computer generated character.

FIG. 5: shows a possible application of the invention for an autonomous robotic device.

FIG. 6: shows a hardware implementation of a method of the invention.

### DETAILED DESCRIPTION OF PREFERRED EMBODIMENTS

The present invention discloses a method of determining behaviour based on visual images and using a memory of objects observed within the visual images.

The present invention will be described in relation to determining behaviour for an autonomous computer generated character or robotic device based upon an image of the environment from the viewing perspective of the character or robot.

In this specification the word “image” refers to an array of pixels in which each pixel includes at least one data bit. Typically an image includes multiple planes of pixel data (i.e. each pixel includes multiple attributes such as luminance, colour, distance from point of view, relative velocity etc.).

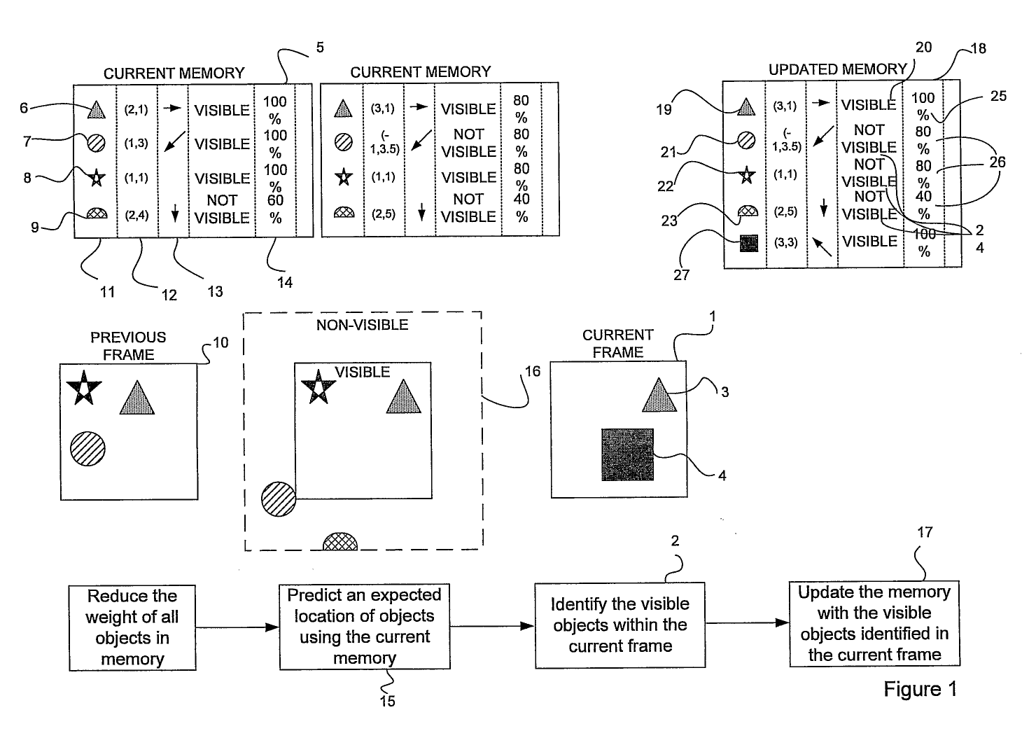

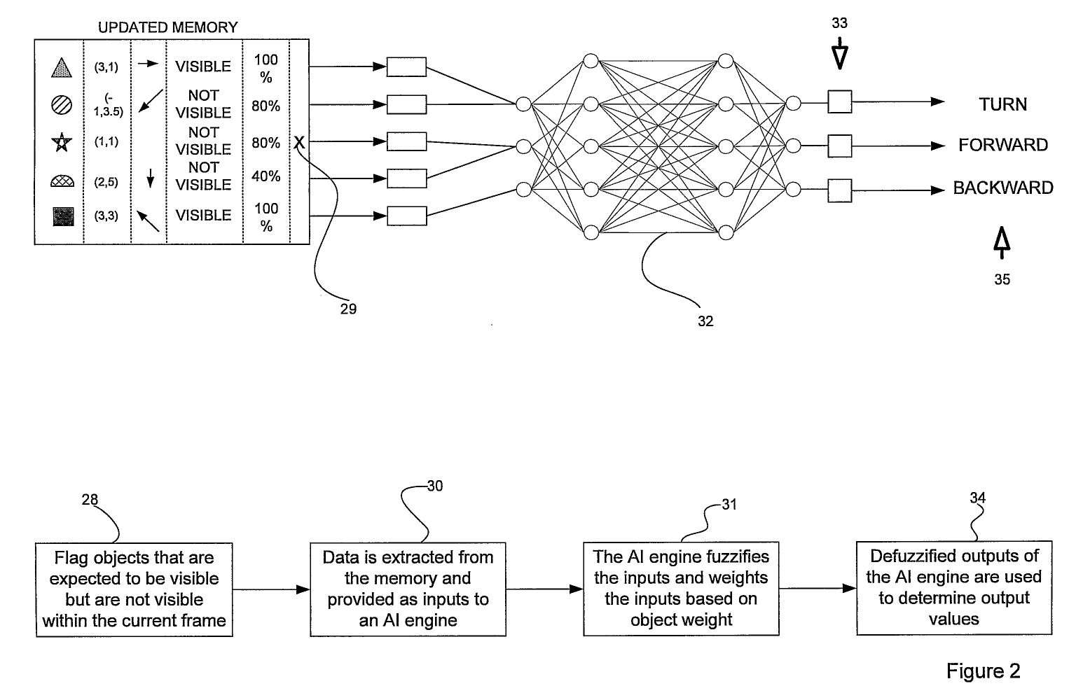

The method of the invention will now be described with reference to FIGS. 1 and 2.

The first step is to process object data within a memory 5 for objects 6, 7, 8, and 9 stored there that have been identified from previous images 10.

The memory contains, for each object stored, the object's type 11, the object's location 12, the object's velocity 13, and a weight 14 given to the object. To achieve more complex results the memory may also contain the object's acceleration.

It will be appreciated that the object's locations may be stored as relative to the entity or in absolute terms.

If there are existing objects within the memory the one step of processing 15 is to generate predicted locations 16 for these objects. This is achieved by using the stored object's location, velocity, and the time since the last prediction.

The locations of the objects in memory are updated to reflect the predicted locations. Another step of processing is to reduce the weight 26 given to all objects within memory.

The weight of high-speed objects may be reduced at higher rates to reflect the greater uncertainty given to high-speed objects.

If the weight of an object is reduced below a set level, the object may be forgotten by deleting from memory.

The next step is to render or obtain an image 1 from the perspective of the entity.

In the case of a computer generated character the image can be rendered using the method of WO/03015034, or can be a frame rendered by any rendering program.

In the case of a robotic device the image can be obtained from a video camera. It will be appreciated that the robotic device can create the image using two or more video cameras to provide depth information.

The next step 2 is to identify objects 3 and 4 within the image from a defined list of object types.

Where the image is computer generated information about the objects can be stored within a layer of the image. In such a case the identification of objects within the image is trivial as each pixel within the layer will be associated with an object identifier. The object identifier will uniquely identify the object and cross-reference to an instance of the object containing information about the object such as object type, location, and velocity.

Where the image is computer generated and there is no layer providing information about the objects, or the image is obtained from a video camera, objects can be identified using a recognition engine.

The recognition engine can use pattern recognition to identify the type of object within the image.

The next step 17 is to update the memory 18 with the objects 3 and 4 identified in the current image 1.

Where the objects have been identified using an object layer to the image, the same instance of the object can be matched to the memory instance of the object.

Where the objects have been identified using pattern recognition, a heuristic system can be used to match the objects identified with the objects stored in memory.

The heuristic system can use such variables as predicted location within a variance window, velocity, and object type, to guess whether an identified object matches to an object stored in memory.

Identified objects 3 that match to stored objects 19 are marked as visible 20 within memory 18. All other objects 21, 22, and 23 in memory are marked as non-visible 24.

The weight 25 of visible objects is set to 100%.

For those identified objects 4 which do not match to any objects stored in memory the following steps are undertaken:
a) The location of the object in 3D space is determined. Firstly, the distance of the object from the entity is determined. If distance information is provided within a layer in the image, the distance can be obtained. Otherwise the distance may be calculated using a stereo image of the object. Given the x and y location of the object in the image and the distance, the location of the object can be calculated. Alternatively if there is an object layer, location can be determined by cross-reference to the object instance.
b) The velocity is determined. Where velocity information is contained within a layer of the image this is trivial. Alternatively if there is an object layer, velocity can be determined by cross-reference to the object instance. In other cases the velocity of a newly identified object may not be determinable. In this case the velocity can be ascertained by comparing the location of the object between a first and second image in time.

The memory is updated to include the new object 27, its location and velocity. The weight of the new object is set at 100%.

The method calculates whether, on the basis of their predicted location and the location and orientation of the entity, whether the objects within memory are expected to be visible from the perspective of the entity or not.

In step 28 those objects 22 that are expected to be visible but are marked as non-visible are flagged 29 as vanished.

In determining whether an object is expected be visible or not, the method accounts for the fact that the object may not in fact be vanished but merely hidden behind other objects.

In a preferred embodiment, only objects that are expected to be visible within a subspace of the image but are marked as non-visible are flagged as vanished. Preferably, the subspace is a rectangular sub-image within the approximate centre of the image. This method provides tolerance for objects at the periphery of the image and prevents flagging objects as vanished when the objects may be just outside the image.

In step 30 data relating to the objects within memory is extracted and provided as inputs to an artificial intelligence engine.

It will be appreciated that the data during extraction from the memory may be further processed. For example, if the co-ordinate data for the object in memory is stored in absolute terms, the co-ordinate data may be processed to provide entity-relative data.

In step 31 the resulting data is provided as inputs to an artificial intelligence engine 32. The artificial intelligence engine weights the inputs depending on the weight given to the object.

The artificial intelligence engine can include fuzzy logic, neural network or binary logic, or any combination of those.

The artificial intelligence engine processes the inputs and provides outputs 33.

Within the artificial intelligence engine the objects are processed according to their type. For example in a fuzzy rules based system, the fuzzy rules are defined by object type. Within a neural network based system, the neurons will not distinguish inputs based on which instance of the object is provided but on the type of object. For this reason data provided from all objects is multiplexed within the artificial intelligence engine across all relevant rules and/or neurons.

It will be appreciated that the artificial intelligence engine may also include as inputs any other information, such as colour, brightness, contrast, distance from point of view, relative velocity, sound etc.

In step 34 the outputs from the engine are used to generate output values 35 for the entity.

In the case of a computer generated character or robot, the output values can include turning, moving forward or backward, make sounds, facial expressions, activation of individual degrees of freedom for muscles (actuators) or motors, or performing any other action.

The generation of output values for the entity over the course of many processing cycles results in generation of a behaviour for the entity.

It will be appreciated that any range of behaviours may be generated, such as obstacle avoidance, navigation, interest tracking, multiple character interaction or the propagation of sound. The behaviour may also include the control of animation blending controls. Animation blending controls may be utilised to initiate play back of animation, blend values to control the relative effect of multiple animations, control animation play back rates etc.

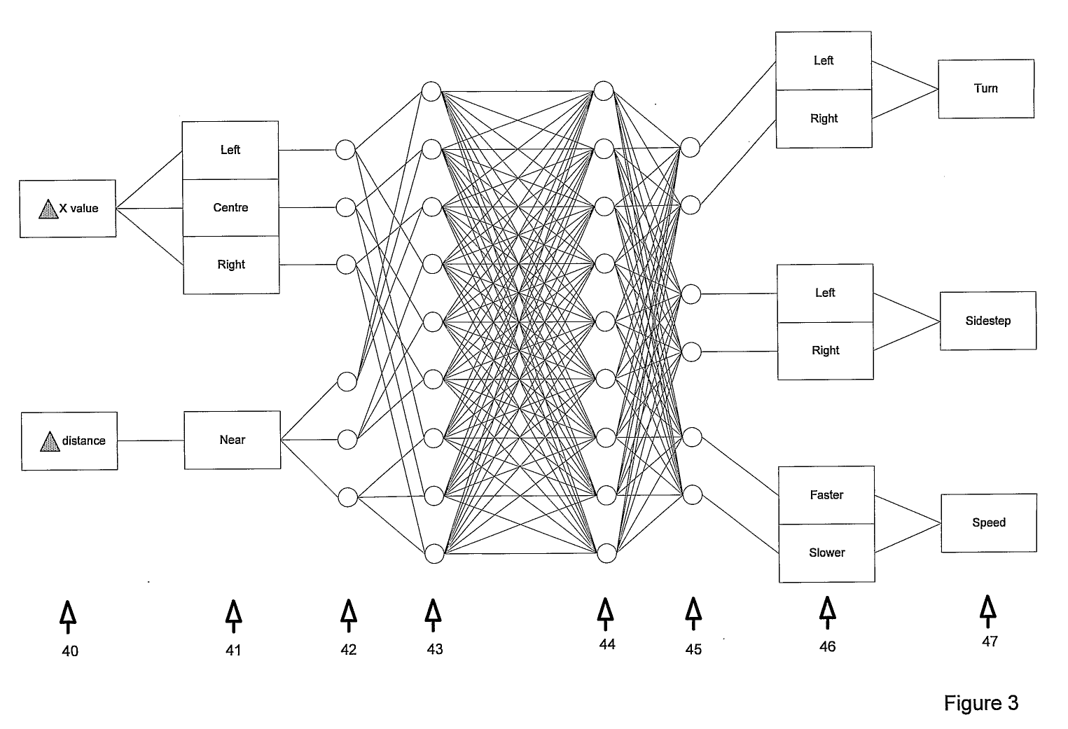

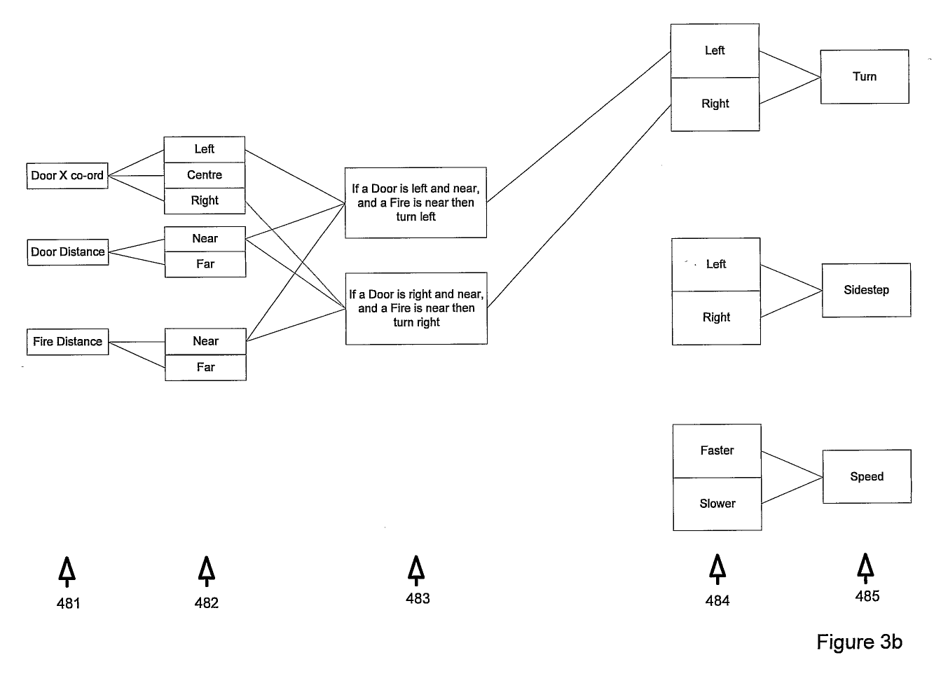

Referring to FIG. 3 an example of an artificial intelligence engine will be described.

Layer 40 shows data extracted from the memory. In the example shown, two inputs representing two items of data about one object type (Triangle) are provided—the x value relative to the entity of the object and the distance from the entity of the object.

Data from all objects in memory that are Triangle objects are multiplexed through layer 40 and into layers 41, 42, and 43. In layer 43 a function for each neuron is applied across the inbound multiplexed values to determine a single valued result of the multiplexing for that neuron. The function may be a fuzzy AND or a weighted sum. It will be appreciated that the function may be any other function capable of producing a single value from multiple inputs.

The layer 41 the first and second inputs are fuzzified to provide inputs to the first layer 42 of a neural network. In the example shown, fuzzy left, centre and right values, and a fuzzy nearness value are computed.

It will appreciated that many other fuzzy values may be computed for data for all the objects in memory.

The weight given to the corresponding object is used as a multiplier within the fuzzification layer 41 to modify the weight given to the fuzzified inputs.

The neural network includes the first input layer 42, two hidden layers 43 and 44, and an output layer 45.

Outputs from the neural network are defuzzified in layer 46 to provide output values for the entity in layer 47.

It will be appreciated that the fuzzified inputs may be provided to a fuzzy network or other Al system.

Referring to FIG. 3b an alternative example of an artificial intelligence engine will be described.

Layer 481 shows the data from object types which is specified to be extracted from memory and provided to the fuzzifier layer of the Al. In the example shown, X co-ordinate data and distance data for the Door object type and distance data for the Fire object type are to be provided to the fuzzifier layer. The distance data is the distance from the entity.

For every object within memory that is a door object, the X co-ordinate and distance data is extracted and provided to the Al engine. For every object within memory that is a fire object, the distance data is extracted and provided to the Al engine.

In this way, data from all doors and all fires are multiplexed through the fuzzifier layer and over the fuzzy rules.

It will be appreciated that the data may be stored in memory as entity-relative form or in absolute form and converted into entity-relative form for the purposes of providing input values to the artificial intelligence engine.

The layer 482 the inputs are fuzzified to provide inputs to a fuzzy rules system in layer 483. In the example shown, fuzzy left, centre and right values are calculated for all x coordinate inputs, and a fuzzy near and far values are calculated for all distance inputs.

The weight given to the corresponding object is used as a multiplier within the fuzzification layer 482 to modify the weight given to the fuzzified inputs.

The fuzzy rules layer 483 is comprised of one or more fuzzy rules each of which receives as inputs fuzzified data multiplexed from all the input values. Each fuzzy rule is defined by using the object type so that general rules can be constructed.

Outputs from the fury rules layer 483 are defuzzified in layer 484 to provide output values for the entity in layer 485.

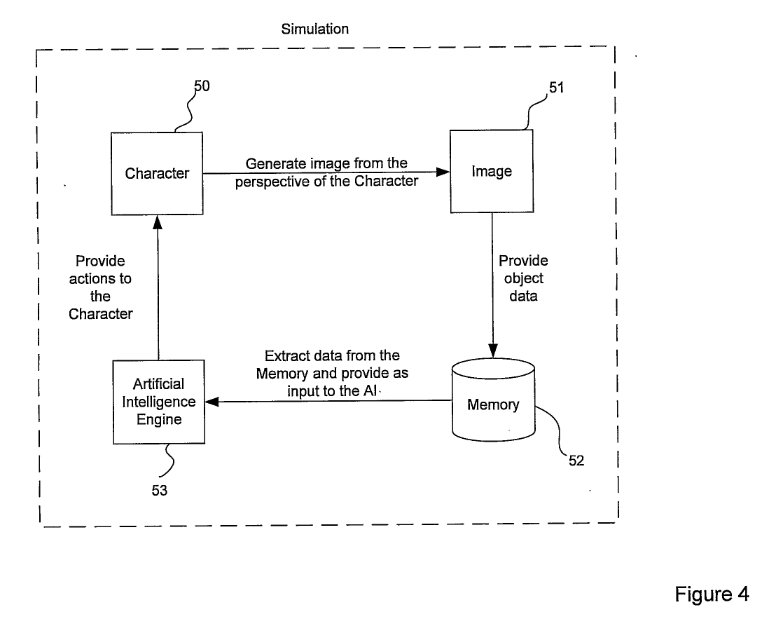

An application for the invention will be described with reference to FIG. 4.

The application relates to the simulation of a computer generated character within an environment. It will be appreciated that the application may include a plurality of computer generated characters, such multiplicity providing useful simulation data.

Information 50 regarding the character is utilised to determine the character's perspective. An image 51 is generated is from this perspective.

Object data from the image is provided for updating the memory 52 for the character.

Data from the memory is provided to the artificial intelligence engine 53.

Data is fuzzified, weighted, and multiplexed within the artificial intelligence engine.

Outputs from the artificial intelligence engine are used to define output values for the character. The output values modify the internal states 50 of the character which as a consequence could change its perspective.

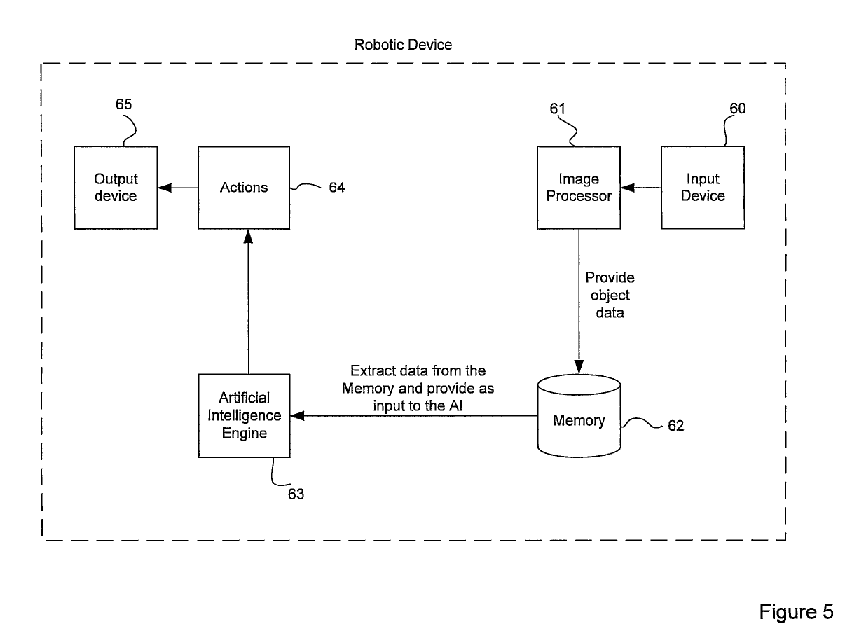

A second application for the invention will be described with reference to FIG. 5.

The application relates to the controlling of a robotic device within an environment.

An image of the environment is provided through an input device 60 such as a camera (or two cameras to provide two images for assisting depth calculation for objects).

The image is processed 61 to recognise objects.

Information relating to the recognised objects is provided to update the memory 62.

Data from the memory is fuzzified, weighted and multiplexed within the artificial intelligence engine 63.

Outputs from the artificial intelligence engine are used to generate actions 64 for the robotic device. The actions may be manifested in the robotic device through an output device 65, such as servos to move the robotic device.

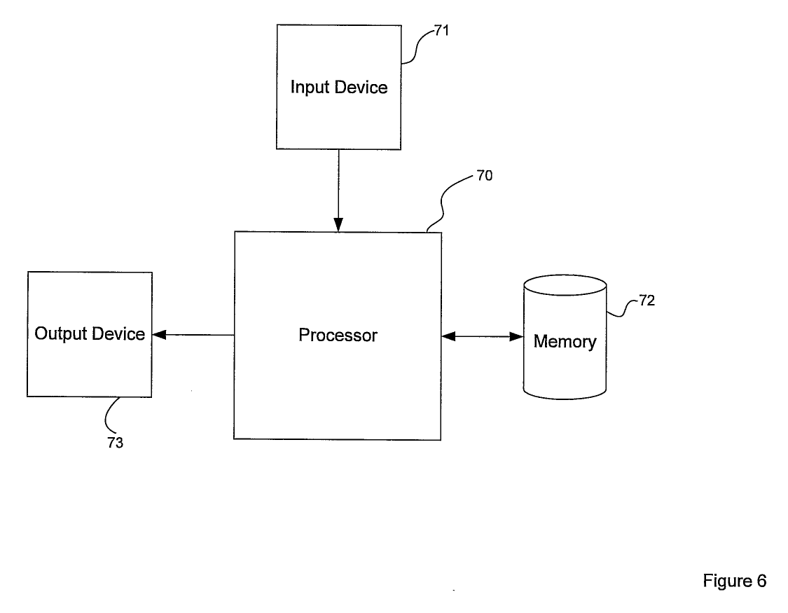

Referring to FIG. 6 hardware for implementing the method of the invention will be described in relation to the execution of a simulation using computer generated characters.

A processor 70 receives data relating to the simulation to be performed from an input device 71. The input device 71 could be a user input device such as a keyboard and/or mouse, or the input device may provide data from a real-world system.

The processor 70 generates an image from the perspective of the computer generated character within the simulation.

The processor 70 detects objects within the image and updates a memory 72 with regard to existing objects within the memory 72 and the detected objects.

Data from the memory 72 is extracted by the processor 70 and supplied to an artificial intelligence engine executing on the processor 70.

The outputs from the artificial intelligence engine are used by the processor 70 to generate behaviour for the computer generated character.

Updates regarding the progress of the simulation are provided by the processor 70 to an output device 73.

The process repeats from the step of the processor generating an image from the character's perspective.

It will be appreciated that modifications can be made to the hardware implementation to provide a system for controlling a robotic device. Such modifications may include an input device, such as a video camera, generating the image and an output device, such as robotic servos, receiving data derived from the generated behaviour.

The method of the invention is easily able to generate cognitive modelling at a much higher level than that obtained using the system described in WO/03015034.

The invention has applicability to engineering simulations, robotic device control, visual effects, and computer games.

For example, software implementing the invention could be used to simulate numerous computer generated characters exiting from a building. This could assist the simulation of the use of exits in an emergency. Use of the invention in this scenario can give rise to complex and realistic behaviour with minimal initial settings. A simulated character could see an exit sign and place into memory, move forward and see nothing that looks like an exit sign, this generating behaviour to turn and go back.

The method of the invention retains all the advantages of WO/03015034 of producing surprisingly natural behaviour utilising only a few simple fuzzy rules—realistic behaviour being more easily achieved due to the realistic nature of the input data; avoiding the need to explicitly compute occlusion, visibility and sensory resolution; and better than n squared scalability for processing times of large numbers of characters in a simulation (typically close to n proportional where n is the number of characters).

The invention thus provides means to simulate an autonomous character(s) in a realistic manner or generate sophisticated behaviour for real-world vision-based systems without high computation requirements.

While the present invention has been illustrated by the description of the embodiments thereof, and while the embodiments have been described in considerable detail, it is not the intention of the applicant to restrict or in any way limit the scope of the appended claims to such detail. Additional advantages and modifications will readily appear to those skilled in the art. Therefore, the invention in its broader aspects is not limited to the specific details representative apparatus and method, and illustrative examples shown and described. Accordingly, departures may be made from such details without departure from the spirit or scope of applicant's general inventive concept.

1. A method for determining behavior of an autonomous entity within an environment using a weighted memory of observed objects, including the steps of:
i. processing observed object data in a weighted memory;
ii. generating an image of an environment from a perspective of an entity;
iii. recognizing visible objects within the image from a list of object types;
iv. storing data about the visible objects within the memory; and
v. processing object data extracted from the memory in accordance with each object's type using an artificial intelligence engine in order to determine behavior for the entity.

2. A method as claimed in claim 1, wherein step (i) includes the sub-step of: modifying the weight of objects stored in the memory.

3. A method as claimed in claim 1, wherein step (i) includes the sub-steps of:
calculating an expected location for the objects within the memory; and modifying location data stored about the objects to correspond to its expected location.

4. A method as claimed in claim 2, wherein the weight of objects is modified by reducing the weight of the objects within memory.

5. A method as claimed in claim 1, wherein the artificial intelligence engine includes a plurality of layers to determine behavior for the entity.

6. A method as claimed in claim 5, wherein at least one of the layers is a fuzzy processing layer.

7. A method as claimed in claim 5, wherein at least one of the layers is a neural network.

8. A method as claimed in claim 5, wherein at least one of the layers is a fuzzy rules layer.

9. A method as claimed in claim 1, wherein during the processing in step (v) object data is multiplexed.

10. A method as claimed in claim 1, wherein the image is generated in step (i) using one or more cameras.

11. A method as claimed in claim 1, wherein the image is generated in step (i) using a renderer.

12. A method as claimed in claim 11, wherein the image is generated by the renderer using a method including the steps of:
a) performing a polar transformation to determine the position(s) of one or more vertices of a graphics primitive;
b) projecting the graphics primitive into sub images;
c) clipping the graphics primitive against the sub images to form clipped primitives;
d) performing polar transformations of the vertices of the clipped images;
e) interpolating across the surface of the clipped primitives to form pseudo polar sub images; and
f) combining the pseudo polar sub images to form an image.

13. A method as claimed in claim 1, wherein the image includes a plurality of layers and wherein one of the layers is an object layer providing information to identify an object instance at the corresponding pixel position.

14. A method as claimed in claim 13, wherein the object instance includes velocity data, 3D location data, and object type.

15. A method as claimed in claim 1, wherein the objects are recognized in step (ii) using a visual recognition technique.

16. A method as claimed in claim 13, wherein the objects are recognized in step (ii) using the object layer.

17. A method as claimed in claim 1, including the step of flagging the objects within memory that are expected to be visible but are not visible.

18. A method as claimed in claim 17, wherein the objects that are expected to be visible are those that are expected to be visible within a sub-image of the image.

19. A method as claimed in claim 18, wherein the sub-image is a rectangular space within the approximate middle of the image.

20. A method as claimed in claim 1, wherein the behavior is determined from one or more output values generated from the artificial intelligence engine and the output values are selected from the set of turning, moving forward or backward, make sounds or facial expressions, activation of individual degrees of freedom for actuators or motors, and controls for animation blending.

21. A method as claimed in claim 1, wherein the entity is a robotic device.

22. A method as claimed in claim 1, wherein the entity is a computer generated character.

23. A method as claimed in claim 1, wherein the environment is a simulated real-world environment.

24. A system for determining behavior of an autonomous entity within an environment using a weighted memory of observed objects, including: a memory arranged for storing the weighted memory of observed objects; and a processor arranged for processing the weighted memory, generating an image of the environment from the perspective of the entity, recognizing visible objects within the image from a list of object types, storing data about the visible objects within the weighted memory, modifying the weight of objects stored in the weighted memory depending on object visibility, and processing object data extracted from the weighted memory in accordance with each object's type using an artificial intelligence engine in order to determine behavior for the entity.

25. The system of claim 24, wherein the processor is further arranged to modifying the weight of objects stored in the weighted memory depending on object visibility.

26. Software arranged for performing the method or system of claim 1.

27. Storage media arranged for storing software as claimed in claim 25.
